(19) United States
(12) Patent Application Publication
(10) Pub. No.: US 2016/0187565 A1
(43) Pub. Date: Jun. 30, 2016

(54) Light Guide Plate and Method for Manufacturing the Same

(71) Applicant: Samsung SDI Co., Ltd., Yongin-si (KR)

(72) Inventors: Woo Suk CHEI, Uiwang-si (KR); Jun Ho CHI, Uiwang-si (KR); Jong Chan HUR, Uiwang-si (KR); Jin Yong BAE, Uiwang-si (KR); Eun Ji SHIN, Uiwang-si (KR)

(21) Appl. No.: 14/982,204

(22) Filed: Dec. 29, 2015

(30) Foreign Application Priority Data
Dec. 31, 2014 (KR) 10-2014-0196077

(51) Int. Cl. F21V 8/00; C08G 64/06

(52) U.S. Cl. CPC G02B 6/0065; G02B 6/0035; C08G 64/06

(57) ABSTRACT

A light guide plate and a method for manufacturing the same are disclosed. The light guide plate is injection-molded from an aromatic polycarbonate resin having a weight average molecular weight of about 10,000 g/mol to about 15,000 g/mol and an alkali metal content of about 40 ppb to about 100 ppb. The light guide plate has a color coordinate y variation (Δy) of about 0.0001 to about 0.0150 after being left at about 80° C. and about 90% RH for about 1,000 hours, and emits light having an about 85% to about 100% brightness of a light source. The light guide plate can exhibit excellent discoloration resistance under high temperature and high humidity conditions and can have small reduction in brightness.

### CROSS-REFERENCE TO RELATED APPLICATION

This application claims priority to and the benefit of Korean Patent Application No. 10-2014-0196077, filed on Dec. 31, 2014 in the Korean Intellectual Property Office, the entire disclosure of which is incorporated herein by reference.

### FIELD

The present invention relates to a light guide plate and a method for manufacturing the same.

### BACKGROUND

Since liquid crystals in a liquid crystal screen of a liquid crystal display (LCD) do not emit light, light entering a front surface of the liquid crystal screen is reflected by a mirror behind the liquid crystals, or a transmitted amount and color of light emitted from a backlight unit (BLU) at a rear side of the LCD are adjusted such that images displayed on the screen can be visible.

FIG. 1 is a schematic sectional view of a typical backlight unit. Referring to FIG. 1, a backlight unit may include a light source 10, a light guide plate 20, a reflective sheet 30, and an optical sheet 40 including a diffusion sheet 42, a prism sheet 44, a protective sheet 46, and the like.

The light source 10 may include self-luminous bodies such as light emitting diodes (LEDs), fluorescent lamps, cold-cathode tubes, laser diodes, organic ELs and the like. Light emitted from the light source 10 is incident on a light-incident surface of the light guide plate 20. The light guide plate 20 serves to emit light by changing point light into sheet light, and may be a wedge shaped light guide plate having a slope on one side thereof, a flat plate-shaped light guide plate, or the like. Light generated from the light source 10 is converted into sheet light of uniform brightness through repetition of total reflection, diffuse reflection, refraction, diffraction and the like inside the light guide plate 20, and is thereby emitted through an upper surface (front surface) and a lower surface (rear surface) of the light guide plate 20. Here, light emitted through the lower surface of the light guide plate 20 is incident on the reflective sheet 30. The reflective sheet 30 reflects and emits the light toward the upper surface of the light guide plate 20. Next, light emitted through the upper surface of the light guide plate 20 is incident on the optical sheet 40. The optical sheet 40 is generally composed of the diffusion sheet 42, the prism sheet 44, the protective sheet 46, and the like. The diffusion sheet 42 serves to diffuse incident light, the prism sheet 44 serves to partially condense the light, and the protective sheet 46 serves to prevent the prism sheet 44 and the diffusion sheet 42 from suffering from defects due to foreign substances, scratches or the like. Generally, as light emitted from the light source passes through the light guide plate 20 and the optical sheet 40, the light exhibits reduced brightness while providing wider viewing angle.

Typically, a light guide plate is mainly formed from a resin composition including polymethyl methacrylate (PMMA) and the like. However, since displays projecting clearer images are required and it is necessary to prevent the light guide plate from being denatured by heat generated from a light source and the like, the resin composition as set forth above is being replaced by aromatic polycarbonate resin compositions exhibiting higher heat resistance. In particular, a light guide plate used in portable displays having a relatively small size is mainly formed from an aromatic polycarbonate resin composition.

Recently, as portable displays such as mobile phones have various sizes, there is a need for larger and thinner light guide plates than existing light guide plates having a size of about 2 inches to about 4 inches and a thickness of about 0.5 mm. Since injection molding is performed at higher temperature than typical molding temperature in order to perform injection molding of the larger and thinner light guide plates, fluidity and replication characteristics of an aromatic polycarbonate resin should be sufficiently secured. However, light guide plates injection-molded at high temperature can generally suffer from yellowing in surface diffusion of light corresponding to a primary function of light guide plates, and also can suffer from accelerated yellowing when used under high temperature and high humidity conditions for a long period of time.

Therefore, there is a need for development of a light guide plate exhibiting excellent discoloration resistance under high temperature and high humidity conditions and having small reduction in brightness.

### SUMMARY OF THE INVENTION

Embodiments provide a light guide plate, which can exhibit excellent discoloration resistance under high temperature and high humidity conditions and can have small reduction in brightness, and a method for manufacturing the same.

The light guide plate is injection-molded from an aromatic polycarbonate resin having a weight average molecular weight of about 10,000 g/mol to about 15,000 g/mol and an alkali metal content of about 40 ppb to about 100 ppb, has a color coordinate y variation (Δy) of about 0.0001 to about 0.0150 after being left at about 80° C. and about 90% relative humidity (RH) for about 1,000 hours, and emits light having about 85% to about 100% brightness of a light source.

In exemplary embodiments, the light guide plate may include a front surface, a rear surface facing the front surface, and a side surface connecting the front surface to the rear surface, wherein the rear surface may include an optical pattern formed thereon.

In exemplary embodiments, the side surface may include: a first side surface with a light source disposed at one side thereof; a second side surface facing the first side surface; a third side surface connecting the first side surface to the second side surface; and a fourth side surface facing the third side surface and connecting the first side surface to the second side surface.

In exemplary embodiments, the aromatic polycarbonate resin may be prepared by melt polymerization.

In exemplary embodiments, the aromatic polycarbonate resin may have a melt index (MI) of about 12 g/10 min to about 30 g/10 min, as measured at about 250° C. under a load of about 10 kgf in accordance with ASTM D1238.

Other embodiments relate to a method for manufacturing the light guide plate as set forth above. The method includes: preparing an aromatic polycarbonate resin having a weight average molecular weight of about 10,000 g/mol to about 15,000 g/mol and an alkali metal content of about 40 ppb to about 100 ppb; and performing injection molding of the aromatic polycarbonate resin.

In exemplary embodiments, injection molding may be performed by heating the aromatic polycarbonate resin to about 330° C. to about 370° C. to prepare a molten resin, followed by injecting the molten resin into a cavity of a mold at an injection rate of about 200 mm/sec to about 1,000 mm/sec.

In exemplary embodiments, the light guide plate manufactured by the method may have a color coordinate y variation (Ay) of about 0.0001 to about 0.0150 after being left at about 80° C. and about 90% RH for about 1,000 hours, and may emit light having about 85% to about 100% brightness of a light source.

In exemplary embodiments, the aromatic polycarbonate resin may have a melt index (MI) of about 12 g/10 min to about 30 g/10 min, as measured at about 250° C. under a load of about 10 kgf in accordance with ASTM D1238.

### BRIEF DESCRIPTION OF DRAWINGS

FIG. 1 is a schematic sectional view of a typical backlight unit.

FIG. 2 is a schematic perspective view of a light guide plate according to one embodiment of the present invention.

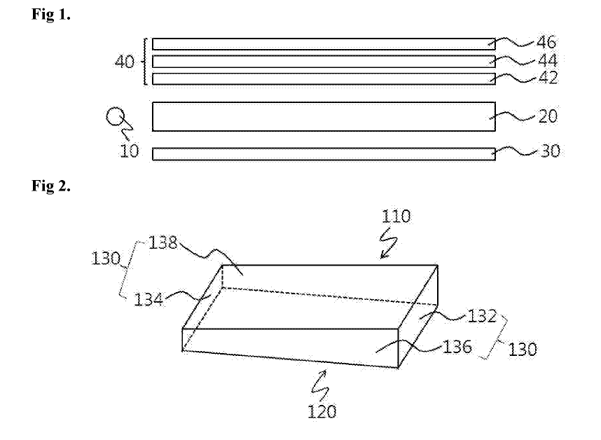

### DETAILED DESCRIPTION

Hereinafter, embodiments of the present invention will be described in detail in the following detailed description with reference to the accompanying drawings, in which some, but not all, embodiments are described. Indeed, this invention may be embodied in many different forms and should not be construed as limited to the embodiments set forth herein; rather, these embodiments are provided so that this disclosure will satisfy applicable legal requirements. It should be understood that the following embodiments are provided for complete disclosure and thorough understanding of the invention by those skilled in the art. In addition, unless otherwise stated, technical and scientific terms as used herein have a meaning generally understood by those skilled in the art. Descriptions of known functions and constructions which can unnecessarily obscure the subject matter of the invention will be omitted.

According to embodiments of the present invention, a light guide plate may be obtained by injection molding an aromatic polycarbonate resin. As used herein, the aromatic polycarbonate resin may have a weight average molecular weight of about 10,000 g/mol to about 15,000 g/mol, for example, about 11,000 g/mol to about 14,000 g/mol, as measured by gel permeation chromatography (GPC), and an alkali metal content of about 40 ppb to about 100 ppb, for example, about 60 ppb to about 100 ppb, as measured using inductively coupled plasma-mass spectrometry (ICP-MS).

If the weight average molecular weight of the aromatic polycarbonate resin is less than about 10,000 g/mol, there is a concern of deterioration in impact resistance of the light guide plate upon molding. If the weight average molecular weight of the aromatic polycarbonate resin is greater than about 15,000 g/mol, there is a concern that the light guide plate having a desired shape is not obtained and/or that the light guide plate can suffer from yellowing.

In addition, if the alkali metal content of the aromatic polycarbonate resin is less than about 40 ppb, there is a concern that the light guide plate suffers from short shot since it is difficult to prepare the polycarbonate resin to a uniform molecular weight through melt polymerization. Further, it is not desirable that the polycarbonate resin be prepared using interfacial polymerization since a lot of cleaning and processes are required to manage the alkali metal content of about 40 ppb or less. If the alkali metal content of the aromatic polycarbonate resin is greater than about 100 ppb, there is a concern that the light guide plate having a desired shape is not obtained and/or that the light guide plate can suffer from yellowing.

In exemplary embodiments, the aromatic polycarbonate resin may be prepared by melt polymerization. For example, the aromatic polycarbonate resin may be prepared by melt polymerization of an aromatic dihydroxy compound and a diaryl carbonate.

The aromatic dihydroxy compound may be a typical aromatic dihydroxy compound used in the preparation of a polycarbonate resin, for example, a compound represented by Formula 1.

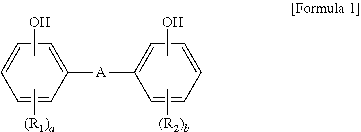

wherein A is a single bond, a substituted or unsubstituted C₁ to C₃₀ hydrocarbon group, —CO—, —S—, or —SO₂—; R₁ and R₂ are the same or different and are each independently a substituted or unsubstituted C₁ to C₃₀ alkyl group or a substituted or unsubstituted C₆ to C₃₀ aryl group; and a and b are the same or different and are each independently an integer of 0 to 4.

Unless otherwise stated, the term “hydrocarbon group” as used herein refers to a linear, branched and/or cyclic saturated or unsaturated hydrocarbon group. The “linear” hydrocarbon group may have a carbon number of 1 to 30. The “branched” hydrocarbon group may have a carbon number of 3 or more, for example 3 to 30, and the “cyclic” hydrocarbon group may have a carbon number of 4 or more, for example 4 to 30. In addition, unless otherwise stated, the term “substituted” as used herein means that a hydrogen atom is substituted with a substituent such as a halogen group, C₁ to C₃₀ alkyl group, C₁ to C₃₀ haloalkyl group, C₆ to C₃₀ aryl group, C₂ to C₃₀ heteroaryl group, C₁ to C₂₀ alkoxy group, and the like, combinations thereof. Also as used herein, unless otherwise stated, the term “hetero” refers to one or more of an oxygen atom (O), a nitrogen atom (N), a sulfur atom (S), a phosphorous atom (P), and the like and combinations thereof.

In exemplary embodiments, A is a single bond, a substituted or unsubstituted C₁ to C₃₀ alkylene group, a substituted or unsubstituted C₂ to C₅ alkenylene group, a substituted or unsubstituted C₂ to C₅ alkylidene group, a substituted or unsubstituted C₅ to C₆ cycloalkylene group, a substituted or unsubstituted C₅ to C₆ cycloalkenylene group, a substituted or unsubstituted C₅ to C₁₀ cycloalkylidene group, a substituted or unsubstituted C₆ to C₃₀ arylene group, a substituted or unsubstituted C₁ to C₂₀ alkoxylene group, a halogen acid ester group, a carbonic acid ester group, —CO—, —S—, or —SO₂—; R₁ and R₂ are the same or different and are each independently a substituted or unsubstituted C₁ to C₃₀ alkyl group, for example, C₁ to C₁₀ alkyl group, or a substituted or unsubstituted C₆ to C₃₀ aryl group, for example, C₆ to C₁₀ aryl group.

Examples of the aromatic dihydroxy compound may include 2,2-bis(4-hydroxyphenyl)propane, 4,4′-biphenol, 2,4-bis(4-hydroxyphenyl)-2-methylbutane, 1,1-bis(4-hydroxyphenyl)cyclohexane, 2,2-bis(3,5-dimethyl-4-hydroxyphenyl)propane, 2,2-bis(3-methyl-4-hydroxyphenyl)propane, 2,2-bis(3-chloro-4-hydroxyphenyl)propane, 2,2-bis(3,5-dichloro-4-hydroxyphenyl)propane, and the like, and combinations thereof, without being limited thereto. In exemplary embodiments, the aromatic dihydroxy compound may include 2,2-bis(4-hydroxyphenyl)propane (“bisphenol A”).

The diaryl carbonate may be a typical diaryl carbonate used for the preparation of a polycarbonate resin, for example, a compound represented by Formula 2.

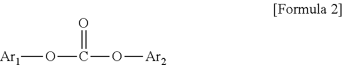

wherein Ar₁ and Ar₂ are the same or different and are each independently a substituted or unsubstituted C₆ to C₂₀ aryl group, for example, a C₆ to C₁₀ aryl group.

Examples of the diaryl carbonate may include diphenyl carbonate, ditolyl carbonate, bis(chlorophenyl) carbonate, m-cresyl carbonate, dinaphthyl carbonate, bis(diphenyl) carbonate, diethyl carbonate, dimethyl carbonate, dipropyl carbonate, dibutyl carbonate, methylethylcarbonate, methylpropyl carbonate, ethylpropyl carbonate, dicyclohexyl carbonate, and the like, and combinations thereof, without being limited thereto. In exemplary embodiments, the diaryl carbonate may include diphenyl carbonate.

In exemplary embodiments, a molar ratio of the aromatic dihydroxy compound to the diaryl carbonate (aromatic dihydroxy compound:diaryl carbonate) may range from about 1:about 0.9 to about 1:about 1.3, for example, about 1:about 0.95 to about 1:about 1.25. Within this range, the aromatic polycarbonate resin can reduce an amount of an unreacted monomer and optimize reactivity due to the content of an end structure.

Melt polymerization may be performed in the presence of a catalyst. The catalyst may be a typical catalyst used in melt polymerization of a polycarbonate resin. Examples of the catalyst may include without limitation an alkali metal catalyst, an alkaline earth metal catalyst, and the like, and combinations thereof. Examples of the alkali metal catalyst may include LiOH, NaOH, and/or KOH, without being limited thereto. These catalysts may be used alone or in combination thereof.

In exemplary embodiments, the catalyst may be present in an amount of about 1×10⁻⁷ parts by weight to about 1×10⁻⁴ parts by weight, for example, about 1×10⁻⁶ parts by weight to about 1×10⁻⁵ parts by weight, based on about 100 parts by weight of the aromatic dihydroxy compound and the diaryl carbonate. Within this range, the aromatic polycarbonate resin having a weight average molecular weight of about 10,000 g/mol to about 15,000 g/mol and an alkali metal content of about 40 ppb to about 100 ppb can be prepared.

Melt polymerization may be performed at a temperature of about 200° C. to about 300° C., for example, about 230° C. to about 270° C. and at a pressure of about 0.1 torr to about 100 torr, for example, about 0.3 torr to about 50 torr for about 1 hour to about 10 hours. Within this range, the aromatic polycarbonate resin having a weight average molecular weight of about 10,000 g/mol to about 15,000 g/mol and an alkali metal content of about 40 ppb to about 100 ppb can be prepared.

In exemplary embodiments, the aromatic polycarbonate resin may have a melt index (MI) of about 12 g/10 min to about 30 g/10 min, for example, about 12 g/10 min to about 20 g/10 min, as measured at about 250° C. under a load of about 10 kgf in accordance with ASTM D1238. Within this range, the aromatic polycarbonate resin can prevent a light guide plate from suffering yellowing.

In exemplary embodiments, the light guide plate can have a color coordinate y variation (Δy) of about 0.0001 to about 0.0150, for example, about 0.0001 to about 0.0130 after being left at about 80° C. and about 90% RH for about 1,000 hours, and can emit light having about 85% to about 100%, for example, about 85% to about 90%, brightness of a light source.

The color coordinate y variation (Δy) of the light guide plate can be calculated by the following method. A manufactured light guide plate is left at room temperature for about 1 day, followed by measurement of a color coordinate y (y₀) in a chromaticity diagram. Then, the light guide plate is left at about 80° C. and about 90% RH for about 1,000 hours, followed by measurement of a color coordinate y (y₁). Then, a difference between y values of the color coordinates (y₁−y₀) is measured. A lower color coordinate y variation (Δy) is preferable. If the color coordinate y variation (Δy) is greater than about 0.0150, the light guide plate can suffer from severe yellowing.

In addition, if brightness of light emitted from the light guide plate with respect to brightness of the light source of the light guide plate is less than about 85%, there is a concern of inefficiency since power consumption can be increased and/or additional components may be required to improve total brightness of a backlight unit.

The light guide plate may have a typical shape of a light guide plate, for example, a wedge shape, a flat plate shape and the like. Regardless of shapes of the light guide plate, at least one convex-concave pattern (pattern such as prism shapes, cylindrical shapes, and the like) may be formed on a slope or a flat surface of the light guide plate. The convex-concave pattern may be formed thereon by replicating a convex-concave portion on a surface of a mold upon injection molding.

FIG. 2 is a schematic perspective view of a light guide plate according to one embodiment of the present invention. As shown in FIG. 2, the light guide plate according to this embodiment includes a front surface 110, a rear surface 120 facing the front surface 110, and a side surface 130 connecting the front surface 110 to the rear surface 120, wherein the rear surface 120 may include an optical pattern (not shown) thereon.

The front surface 110 may face a display panel (LCD panel or the like) and allow an image to be displayed thereon by guiding light emitted from a lateral light source toward the panel.

The rear surface 120 faces the front surface 110 and can improve optical efficiency by reflecting some of light from the lateral light source toward the front surface 110. When the rear surface 120 includes an optical pattern formed thereon, the optical pattern can allow light of the light source to be totally reflected after the light strikes the optical pattern and to be emitted through the front surface 110 toward the panel, thereby improving optical efficiency of the light guide plate.

The optical pattern is not limited and can include, for example, engraved shapes, embossed shapes and mixtures thereof and may be randomly formed without limitation with respect to density, separation distance and the like so long as the optical pattern can reflect light from the lateral light source. In addition, the optical pattern may have a shape such as cones, prism bars and the like, without being limited thereto. The optical pattern may have a height of about 6 μm to about 30 μm and a width or diameter of about 10 μm to about 35 μm, without being limited thereto.

The side surface 130 may include: a first side surface 132 with a light source disposed at one side thereof; a second side surface 134 facing the first side surface 132; a third side surface 136 connecting the first side surface 132 to the second side surface 134; and a fourth side surface 138 facing the third side surface 136 and connecting the first side surface 132 to the second side surface 134.

According to exemplary embodiments, a method for manufacturing a light guide plate includes: preparing an aromatic polycarbonate resin through melt polymerization as described above; and performing injection molding of the aromatic polycarbonate resin.

In exemplary embodiments, injection molding may be performed by heating the aromatic polycarbonate resin to about 330° C. to about 370° C., for example, about 340° C. to about 360° C. to prepare a molten resin, followed by injecting the molten resin into a cavity of a mold at an injection rate of about 200 mm/sec to about 1,000 mm/sec, for example, about 300 mm/sec to about 800 mm/sec.

If the heating temperature is less than about 330° C., there is a concern that a light guide plate having a desired shape is not obtained due to deterioration in fluidity of the aromatic polycarbonate resin. If the heating temperature is greater than about 370° C., there is a concern of yellowing due to discoloration of the aromatic polycarbonate resin.

In addition, if the injection rate is less than about 200 mm/sec, there is a concern that a light guide plate having a desired shape is not obtained since the molten resin does not completely fill the cavity of the mold. If the injection rate is greater than about 1,000 mm/sec, there is a concern of yellowing due to increase in thermal history of the mold.

In exemplary embodiments, injection molding may be performed using a typical steel mold, a heat-insulating mold which uses a material of low thermal conductivity (ceramics, resins such as polyimides, and the like) as a portion of the mold, a method of selectively performing rapid heating and rapid cooling of a mold surface, and the like. For example, injection molding may be performed using a heat-insulating mold formed of zirconia ceramic. Use of the heat-insulating mold can be more suitable for the preparation of a light guide plate exhibiting excellent replication of a fine convex-concave pattern, since formation of a solidified layer due to rapid cooling of the molten resin in the cavity of the mold can be avoided and it can be easy to fill the cavity with a polycarbonate resin as compared with general steel molds even though the mold has extremely thin thickness.

Hereinafter, the present invention will be described in more detail with reference to the following examples. However, it should be noted that these examples are provided for illustration only and are not to be construed in any way as limiting the present invention.

### EXAMPLES

### Preparative Example 1

A polycarbonate resin is prepared through melt polymerization of diphenyl carbonate and bisphenol-A. In preparation of the polycarbonate resin, a KOH catalyst is added in an amount of 100 ppb based on 100 parts by weight of diphenyl carbonate and bisphenol-A. The prepared polycarbonate resin has a weight average molecular weight of 15,000 g/mol and a melt index (MI, conditions: 250° C. and 10 kgf) of 12.5 g/10 min.

### Preparative Example 2

A polycarbonate resin is prepared in the same manner as in Preparative Example 1 except that the KOH catalyst is added in an amount of 80 ppb based on 100 parts by weight of diphenyl carbonate and bisphenol-A. The prepared polycarbonate resin has a weight average molecular weight of 15,000 g/mol and a melt index (MI, conditions: 250° C. and 10 kgf) of 12.5 g/10 min.

### Preparative Example 3

A polycarbonate resin is prepared in the same manner as in Preparative Example 1 except that the KOH catalyst is added in an amount of 60 ppb based on 100 parts by weight of diphenyl carbonate and bisphenol-A. The prepared polycarbonate resin has a weight average molecular weight of 15,000 g/mol and a melt index (MI, conditions: 250° C. and 10 kgf) of 12.5 g/10 min.

### Preparative Example 4

A polycarbonate resin is prepared in the same manner as in Preparative Example 1 except that a NaOH catalyst is added in an amount of 80 ppb based on 100 parts by weight of diphenyl carbonate and bisphenol-A. The prepared polycarbonate resin has a weight average molecular weight of 15,000 g/mol and a melt index (MI, conditions: 250° C. and 10 kgf) of 12.5 g/10 min.

### Preparative Example 5

A polycarbonate resin is prepared through melt polymerization of diphenyl carbonate and bisphenol-A. In preparation of the polycarbonate resin, a KOH catalyst is added in an amount of 200 ppb based on 100 parts by weight of diphenyl carbonate and bisphenol-A. The prepared polycarbonate resin has a weight average molecular weight of 15,000 g/mol and a melt index (MI, conditions: 250° C. and 10 kgf) of 12.5 g/10 min.

### Preparative Example 6

A polycarbonate resin is prepared in the same manner as in Preparative Example 5 except that a KOH catalyst is added in an amount of 150 ppb based on 100 parts by weight of diphenyl carbonate and bisphenol-A. The prepared polycarbonate resin has a weight average molecular weight of 15,000 g/mol and a melt index (MI, conditions: 250° C. and 10 kgf) of 12.5 g/10 min.

### Preparative Example 7

A polycarbonate resin is prepared through interfacial polymerization of phosgene and bisphenol-A. The polycarbonate resin has an alkali metal (K) content of 200 ppb, a weight average molecular weight of 15,000 g/mol and a melt index (MI, conditions: 250° C. and 10 kgf) of 12.5 g/10 min.

### Example 1

A light guide plate is manufactured by injection molding of the polycarbonate resin prepared in Preparative Example 1 at an injection molding temperature of 340° C. using an injection molding machine including a mold for navigation having a size of 7 inches and a thickness of 0.7 mm (model: SE-180, Sumitomo Co., Ltd., mold temperature: 90° C., injection rate: 320 mm/sec). The manufactured light guide plate is evaluated as to the following properties. Results are shown in Table 1.

### Example 2

A light guide plate is manufactured in the same manner as in Example 1 except that the polycarbonate resin prepared in Preparative Example 2 is used instead of the polycarbonate resin prepared in Preparative Example 1. The manufactured light guide plate is evaluated as to the following properties. Results are shown in Table 1.

### Example 3

A light guide plate is manufactured in the same manner as in Example 1 except that the polycarbonate resin prepared in Preparative Example 3 is used instead of the polycarbonate resin prepared in Preparative Example 1. The manufactured light guide plate is evaluated as to the following properties. Results are shown in Table 1.

### Example 4

A light guide plate is manufactured in the same manner as in Example 1 except that the polycarbonate resin prepared in Preparative Example 4 is used instead of the polycarbonate resin prepared in Preparative Example 1. The manufactured light guide plate is evaluated as to the following properties. Results are shown in Table 1.

### Comparative Example 1

A light guide plate is manufactured in the same manner as in Example 1 except that the polycarbonate resin prepared in Preparative Example 5 is used instead of the polycarbonate resin prepared in Preparative Example 1. The manufactured light guide plate is evaluated as to the following properties. Results are shown in Table 1.

### Comparative Example 2

A light guide plate is manufactured in the same manner as in Example 1 except that the polycarbonate resin prepared in Preparative Example 6 is used instead of the polycarbonate resin prepared in Preparative Example 1. The manufactured light guide plate is evaluated as to the following properties. Results are shown in Table 1.

### Comparative Example 3

A light guide plate is manufactured in the same manner as in Example 1 except that the polycarbonate resin prepared in Preparative Example 7 is used instead of the polycarbonate resin prepared in Preparative Example 1. The manufactured light guide plate is evaluated as to the following properties. Results are shown in Table 1.

Evaluation of Properties

(1) Weight average molecular weight (unit: g/mol): Weight average molecular weight is measured by gel permeation chromatography (GPC).

(2) Melt index (MI, unit: g/10 min): Melt index is measured at 250° C. under a load of 10 kgf in accordance with ASTM D1238.

(3) Alkali metal content (unit: ppb (on a weight basis)): Alkali metal content is measured using inductively coupled plasma-mass spectrometry (ICP-MS).

(4) A BLU including an injection-molded light guide plate is assembled, followed by evaluation of high temperature/high humidity reliability at 80° C. and 90% RH for 1,000 hours using a thermos-hygrostat (SMS2). Color coordinates are measured using a colorimeter (Topcon rapid BM-7). A color coordinate y variation (Δy) and a color coordinate x variation (Δx) of the light guide plate are calculated as follows. The prepared light guide plate is left at room temperature for 1 day, followed by measurement of a color coordinate y (y₀) and a color coordinate x (x₀) in a chromaticity diagram using a colorimeter. Next, the light guide plate is left at 80° C. and 90% RH for 1,000 hours, followed by measurement of a color coordinate y (y₁) and a color coordinate x (x₁), thereby calculating a difference between the y values of the color coordinates (y₁−y₀) and a difference between the x values of the color coordinates (x₁−x₀).

TABLE 1

| | | | | | | Comparative | Comparative | Comparative |
|---|---|---|---|---|---|---|---|---|
| | Unit | Example 1 | Example 2 | Example 3 | Example 4 | Example 1 | Example 2 | Example 3 |
| Polycarbonate resin | — | Preparative | Preparative | Preparative | Preparative | Preparative | Preparative | Preparative |
| | | Example 1 | Example 2 | Example 3 | Example 4 | Example 5 | Example 6 | Example 7 |
| Alkali metal (K) | ppb | 100 | 80 | 60 | — | 200 | 150 | 200 |
| content | | | | | | | | |
| Alkali metal (Na) | ppb | — | — | — | 80 | — | — | — |
| content | | | | | | | | |
| Color coordinate x | — | 0.2895 | 0.2914 | 0.2915 | 0.2920 | 0.2920 | 0.2895 | 0.2909 |
| before experiment | | | | | | | | |
| Color coordinate y | — | 0.2728 | 0.2771 | 0.2750 | 0.2765 | 0.2795 | 0.2785 | 0.2748 |
| before experiment | | | | | | | | |
| Color coordinate x | — | 0.2982 | 0.2930 | 0.2932 | 0.3005 | 0.3050 | 0.2985 | 0.3079 |
| after experiment | | | | | | | | |
| Color coordinate y | — | 0.2842 | 0.2772 | 0.2778 | 0.2877 | 0.2975 | 0.2946 | 0.3008 |
| after experiment | | | | | | | | |
| Color coordinate x | — | 0.0087 | 0.0016 | 0.0017 | 0.0085 | 0.0130 | 0.0090 | 0.0170 |
| variation (Δx) | | | | | | | | |
| Color coordinate x | — | 0.0114 | 0.0001 | 0.0028 | 0.0112 | 0.0180 | 0.0161 | 0.0260 |
| variation (Δy) | | | | | | | | |
| Brightness | — | 88% | 89% | 87% | 86% | 85% | 87% | 86% |
| uniformity after | | | | | | | | |
| experiment | | | | | | | | |

From the results of Table 1, it can be seen that the light guide plate according to the present invention exhibits excellent discoloration resistance (color coordinate y variation (Δy) of 0.0114 or less) and has small reduction in brightness due to brightness uniformity of 86% or more after the experiment.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. The scope of the present invention is defined by the appended claims and equivalents thereof.

What is claimed is:

1. A light guide plate injection-molded from an aromatic polycarbonate resin having a weight average molecular weight of about 10,000 g/mol to about 15,000 g/mol and an alkali metal content of about 40 ppb to about 100 ppb,
wherein the light guide plate has a color coordinate y variation (Δy) of about 0.0001 to about 0.0150 after being left at about 80° C. and about 90% RH for about 1,000 hours, and emits light having about 85% to about 100% brightness of a light source.

2. The light guide plate according to claim 1, comprising: a front surface; a rear surface facing the front surface; and a side surface connecting the front surface to the rear surface, wherein the rear surface comprises an optical pattern formed thereon.

3. The light guide plate according to claim 2, wherein the side surface comprises: a first side surface with a light source disposed at one side thereof; a second side surface facing the first side surface; a third side surface connecting the first side surface to the second side surface; and a fourth side surface facing the third side surface and connecting the first side surface to the second side surface.

4. The light guide plate according to claim 1, wherein the aromatic polycarbonate resin is prepared by melt polymerization.

5. The light guide plate according to claim 1, wherein the aromatic polycarbonate resin has a melt index (MI) of about 12 g/10 min to about 30 g/10 min, as measured at about 250° C. under a load of about 10 kgf in accordance with ASTM D1238.

6. A method for manufacturing a light guide plate, comprising:
preparing an aromatic polycarbonate resin having a weight average molecular weight of about 10,000 g/mol to about 15,000 g/mol and an alkali metal content of about 40 ppb to about 100 ppb by melt polymerization of an aromatic dihydroxy compound and a diaryl carbonate; and
performing injection molding of the aromatic polycarbonate resin.

7. The method according to claim 6, wherein injection molding is performed by heating the aromatic polycarbonate resin to about 330° C. to about 370° C. to prepare a molten resin, followed by injecting the molten resin into a cavity of a mold at an injection rate of about 200 mm/sec to about 1,000 mm/sec.

8. The method according to claim 6, wherein a light guide plate manufactured by the method has a color coordinate y variation (Δy) of about 0.0001 to about 0.0150 after being left at about 80° C. and about 90% RH for about 1,000 hours, and emits light having about 85% to about 100% brightness of a light source.

9. The method according to claim 6, wherein the aromatic polycarbonate resin has a melt index (MI) of about 12 g/10 min to about 30 g/10 min, as measured at about 250° C. under a load of about 10 kgf in accordance with ASTM D1238.
